(19) United States
(12) Patent Application Publication
(10) Pub. No.: US 2013/0022825 A1
(43) Pub. Date: Jan. 24, 2013

(54) Films Made Of Plasticizer-Containing Polyvinyl (Iso)Acetal

(71) Applicants: Markus Meise, Mannheim (DE); Jan Beekhuizen, Troisdorf (DE); Martin Steuer, Liederbach (DE); Uwe Keller, Bonn (DE); Michael Frank, Nieder-Olm (DE)

(72) Inventors: Markus Meise, Mannheim (DE); Jan Beekhuizen, Troisdorf (DE); Martin Steuer, Liederbach (DE); Uwe Keller, Bonn (DE); Michael Frank, Nieder-Olm (DE)

(73) Assignee: KURARAY EUROPE GMBH, Hattersheim (DE)

(21) Appl. No.: 13/552,683

(22) Filed: Jul. 19, 2012

(30) Foreign Application Priority Data
Jul. 22, 2011 (EP) 11175088.1

(51) Int. Cl. C08L 29/14; B32B 17/10; B32B 27/30; C08K 5/12

(52) U.S. Cl. 428/441; 524/296; 524/285; 428/500

(57) ABSTRACT

A film contains a mixture of at least one non-aromatic plasticizer having a polarity, expressed by the formula 100×O/(C+H), of less than/equal to 9.4 wherein O, C and H represent the number of oxygen, carbon and hydrogen atoms in the respective molecule, and a polyvinyl (iso)acetal having a proportion of polyvinyl (iso)acetal groups of 60 to 85% by weight and a proportion of polyvinyl alcohol groups of 14 to 40% by weight. The films may be used in the automotive industry, in windscreens, in the field of architecture, in façade components, or for the production of photovoltaic modules.

### CROSS-REFERENCE TO RELATED APPLICATIONS

This application claims priority to European Patent Application No. 11175088.1 filed Jul. 22, 2011 which is herein incorporated by reference.

### BACKGROUND OF THE INVENTION

1. Field of the Invention

The invention relates to plasticizer-containing films based on polyvinyl (iso)acetals. The films are suitable for example as an intermediate layer in laminated safety glazings or adhesive films in photovoltaic modules.

2. Background Art

Laminated safety glazings generally consist of two glass panes and an intermediate film connecting the glass panes. Plasticizer-containing polyvinyl butyral (PVB) is predominantly used as film material and is obtainable by reacting polyvinyl alcohol with n-butyraldehyde.

The mechanical strength and moisture absorption of such films is determined, inter alia, by the type and amount of plasticizer. Polyvinyl butyral has a different absorption capacity for each plasticizer, above which the plasticizer exudes from the film.

In order to obtain a PVB film having softening temperatures in the range of normal application temperatures (0 to 40° C.), specific general conditions with respect to the chemical nature of the PVB and of the plasticizer and with respect to the mixing ratios with the plasticizer have to be observed. The plasticizer 3G8 (triethylene glycol-bis-2-ethylhexanoate) has previously been used as a plasticizer for PVB films. For this plasticizer, EP 0877665 describes the absorption capacities of PVB with different residual vinyl alcohol contents.

In addition to limited plasticizer absorption, the known PVB films based on n-butyraldehyde have relatively high moisture absorption, which may lead to undesirable cloudiness in safety glazings. For use in photovoltaic modules, the high moisture absorption may lead to low volume resistivity, which is undesirable. In addition, absorption of moisture may lead to exudation of plasticizer, in particular at elevated temperatures.

It would therefore be desirable to use mixtures of PVB containing higher proportions of non-polar plasticizers for film production so as to counteract the undesirable moisture absorption.

Mixtures of polyvinyl (iso)acetal with dibutyl phthalate as plasticizer are described by J. Fitzhugh and R Croizer J. Polym. Sci (1951) Vol VIII, p. 225-241. This publication does not concern the production of films and use thereof. In addition, only polar aromatic plasticizers are used in that instance.

Plasticizer-containing polyvinyl (iso)acetals are also known from US 2008/0286542 for the production of intermediate-layer films for decorative glass elements. The polyvinyl (iso)acetals described in that instance for laminate safety glazings have an excessively low degree of acetalisation of 8 to 30% by weight and therefore exhibit insufficient plasticizer absorption. Accordingly, U.S. 2008/0286542 discloses merely multi-layered films, in which plasticizer-containing polyvinyl (iso)acetal having a low degree of acetalisation is laminated between two layers of plasticizer-containing polyvinyl (n) acetal.

Film laminates without use of polyvinyl (iso)acetal are known for example from WO 2006/102049 A1, WO 2011/078314 A1, WO 2011/081190 A1, WO 2011/024788 A1, US 2007014976 and JP 2011042552. The advantageous properties of polyvinyl (iso)acetal are not described herein.

### SUMMARY OF THE INVENTION

It has now surprisingly been found that polyvinyl (iso)acetals have greater plasticizer compatibility compared to polyvinyl (n) acetals. The problems of the prior art have been mitigated or eliminated by the use of films of polyvinyl (isolacetals having a high degree of acetalization, containing a polar, aliphatic plasticizer. It has surprisingly been found that polyvinyl (iso)acetals have improved plasticizer compatibility at constant polyvinyl alcohol content (PVA content) compared to corresponding polyvinyl (n) acetals.

### DETAILED DESCRIPTION OF THE PREFERRED EMBODIMENT(S)

The present invention thus relates to films containing a mixture of at least one non-aromatic plasticizer having a polarity, expressed by the formula 100×O/(C+H), wherein O, C and H represent the number of oxygen, carbon and hydrogen atoms in the respective plasticizer molecule of less than/equal to 9.4 and a polyvinyl (iso)acetal having a proportion of polyvinyl (iso)acetal groups of 60 to 85% by weight and a proportion of polyvinyl alcohol groups of 14 to 40% by weight.

Improved plasticizer compatibility results in lower exudation of the plasticizer from a mixture with polyvinyl (iso)acetals during storage at room temperature. Exudation of plasticizer becomes noticeable as a film of plasticizer over the film surface.

Exudation of plasticizer indicates a lack of compatibility between the polymer and the plasticizer. This effect can be determined by the “cloud point”. The compatibility between a polyvinyl acetal and a plasticizer, such as 3G8, is tested for example by slowly cooling a hot solution of the polyvinyl acetal in the plasticizer in question. The lower the temperature at which the solution becomes cloudy, the more compatible are the polymer and the plasticizer.

It has been possible to establish that the cloud points for polyvinyl acetals based on iso-butyraldehyde are significantly lower than that of the same polyvinyl acetals based on n-butyraldehyde. This means that, with a given PVA content of the polyvinyl (iso)acetals used, the films according to the invention contain more plasticizer than films based on polyvinyl-n-butyral with the same PVA content. A higher plasticizer content results in more cost effective production of the film, since the plasticizers are generally less expensive than the polyvinyl acetal.

Films according to the invention do not contain any aromatic plasticizers, that is to say no plasticizers having an aromatic sub-structure, such as phthalates (in particular no dibutyl phthalate) or benzoates.

The films according to the invention contain plasticizer-containing polyvinyl (iso)acetals, which are obtained by acetalisation of a completely or partially saponified polyvinyl alcohol with branched keto compounds.

The polyvinyl (iso)acetal groups of the polyvinyl (iso)acetal are preferably obtained by reacting at least one polyvinyl alcohol with one or more aliphatic keto compounds containing 4 to 10 carbon atoms and having at least one branch at the position alpha or beta to the keto group. It is also possible, in addition, to use unbranched aliphatic keto compounds containing 2 to 10 carbon atoms for acetalisation. However, the proportion of branched keto compounds should be more than 50% by weight of the sum of branched and unbranched keto compounds.

The polyvinyl alcohol content of the polyvinyl (iso)acetals can be adjusted by the amount of the aldehyde used during acetalisation. It is also possible to carry out the acetalisation process using a plurality of aldehydes.

The polyvinyl acetate content of the polyvinyl (iso)acetals used in accordance with the invention can be adjusted by use of a polyvinyl alcohol hydrolysed to a corresponding proportion. The polarity of the polyvinyl (iso)acetal is influenced by the polyvinyl acetate content, whereby the plasticizer compatibility of the film is also changed.

The polyvinyl (iso)acetals preferably have a proportion of polyvinyl acetate groups of 0.1 to 15% by weight, more preferably 0.1 to 8% by weight, and in particular 0.1 to 3% by weight. A proportion of polyvinyl acetate groups of 0.5 to 2% by weight is most preferred. Furthermore it is within the scope of the invention that the film comprises polyvinyl (iso)acetals have a mean a proportion of polyvinyl acetate groups between 4 and 8 Mol %, for example between 4.1 and 7.9 Mol % or between 5 and 7 Mol %.

The use of crosslinked polyvinyl (iso)acetals, in particular crosslinked polyvinyl (iso)butyral, is also possible. Suitable methods for crosslinking are described for example in EP 1527107 B1 and WO 2004/063231 A1 (thermal self-crosslinking of polyvinyl acetals containing carboxyl groups), EP 1606325 A1 (polyvinyl acetals crosslinked with polyaldehydes) and WO 03/020776 A1 (polyvinyl acetals crosslinked with glyoxylic acid).

So as not to impair the processing of the films, the use of crosslinked polyvinyl (iso)acetals, which have a solution viscosity increased by 25 to 200% compared to the respective uncrosslinked material is particularly preferred. For example, the uncrosslinked material may thus have a solution viscosity of 80 mPas and the crosslinked material may have a solution viscosity of 100 to 250 mPas. The co-acetalisation of polyvinyl alcohols with a mixture of the aforementioned keto compounds and dialdehydes or trialdehydes, such as glutardialdehyde, according to WO 03/020776 A1 lends itself to the production of crosslinked polyvinyl (iso)acetals.

To produce polyvinyl (iso)acetal, polyvinyl alcohol is dissolved in water and acetalised with a keto compound such as iso-butyraldehyde with the addition of an acid catalyst. The precipitated polyvinyl acetal is separated, washed neutral, optionally suspended in an aqueous medium set to an alkaline pH, then washed neutral again and dried.

Within the scope of the present invention, the polyvinyl alcohols may be used in pure form or in the form of a mixture of polyvinyl alcohols having a different degree of polymerisation or degree of hydrolysis.

The polyvinyl (iso)acetal used for films of the invention can have a mean degree of polymerisation of less than 3000, preferably between 200 and 2800, and most preferably between 900 and 2500.

Generally, the compatibility between plasticizer and polyvinyl acetals decreases with a drop in the polar nature of the plasticizer. Plasticizers of relatively high polarity are therefore more compatible with polyvinyl acetal than those of relatively low polarity. Alternatively, the compatibility of plasticizers of low polarity increases with a rise in the degree of acetalisation, that is to say with a drop in the number of hydroxyl groups and therefore in the polarity, of the polyvinyl acetal.

Due to the branchings of the acetal groups, the films according to the invention have different softening points compared to conventional systems based on straight-chain aldehydes. Films according to the invention preferably have a softening point Tg of −11 to 24° C.

In addition to the moisture content, the softening points also play a key role for the electrical volume resistivity of films based on polyvinyl acetal. Films according to the invention therefore have a higher softening point and also a higher electrical volume resistivity at a given moisture and temperature compared to films based on polyvinyl (n) acetal having the same plasticizer content. This is advantageous for use in photovoltaic modules, since the electrical volume resistivity is important for the longevity of the modules.

The films according to the invention may contain plasticizers or plasticizer mixtures from at least one of the following non-aromatic plasticizers:

esters of polyvalent aliphatic acids, for example dialkyl adipates such as dihexyl adipate, dioctyl adipate, hexylcyclohexyl adipate, mixtures of heptyl adipates and nonyl adipates, diisononyl adipate, heptylnonyl adipate, and esters of adipic acid with cycloaliphatic ester alcohols or ester alcohols containing ether bonds, dialkyl sebacates such as dibutyl sebacate, and esters of sebacic acid with cycloaliphatic ester alcohols or ester alcohols containing ether bonds, esters of cyclohexane dicarboxylic acid such as 1,2-cyclohexane dicarboxylic acid diisononyl ester;

esters or ethers of polyvalent aliphatic alcohols or oligoether glycols with one or more unbranched or branched aliphatic substituents, such as esters of diglycols, triglycols or tetraglycols with linear or branched aliphatic or cycloaliphatic carboxylic acids; examples of this last group include diethylene glycol-bis-(2-ethylhexanoate), triethylene glycol-bis-(2-ethylhexanoate), triethylene glycol-bis-(2-ethylbutanoate), tetraethylene glycol-bis-n-heptanoate, triethylene glycol-bis-n-heptanoate, triethylene glycol-bis-n-hexanoate, and/or tetraethylene glycol dimethyl ether;

phosphates of aliphatic ester alcohols, such as tris(2-ethylhexyl) phosphate (TOF), and triethyl phosphate;

esters of citric acid, succinic acid, and/or fumaric acid; and diisononyl adipate (DINA) and di-(2-butoxyethyl) adipate (DBEA)

Non-aromatic plasticizers of which the polarity, expressed by the formula 100×O/(C+H), is less than/equal to 9.4, wherein O, C and H represent the number of oxygen, carbon and hydrogen atoms in the respective molecule, are most suitable as plasticizers for the films according to the invention. The table below shows plasticizers which can be used in accordance with the invention and the polarity values thereof according to the formula 100×0/(C+H).

| | 100 × O/ |
|---|---|
| Name | (C + H) |
| di-2-ethylhexyl sebacate (DOS) | 5.3 |
| di-2-ethylhexyl adipate (DOA) | 6.3 |
| triethylene glycol-bis-2-propyl hexanoate | 8.6 |
| triethylene glycol-bis-i-nonanoate | 8.6 |
| di-2-butoxyethyl sebacate (DBES) | 9.4 |
| triethylene glycol-bis-2-ethyl hexanoate (3G8) | 9.4 |
| 1,2-cyclohexane dicarboxylic acid diisononyl ester (DINCH) | 5.4 |

According to this formula, Triethylenglycol-bis-2-ethylbutyrate has a polarity of 11.11 and is in mixtures with polyvinyl(iso)acetales and is not suitable for the production of films.

In addition, the films according to the invention may contain further additives known to those skilled in the art, such as residual amounts of water, UV absorbers, antioxidants, adhesion regulators, optical brighteners, stabilisers, dyes, processing aids, organic or inorganic nanoparticles, pyrogenic silicic acid, and/or surface-active substances.

Within the scope of the present invention, adhesion regulators are understood to mean compounds with which the adhesion of plasticizer-containing polyvinyl acetal films to glass surfaces can be adjusted. Compounds of this type are known to those skilled in the art; alkaline or alkaline earth metal salts of organic acids, such as potassium/magnesium acetate, are often used in practice for this purpose.

To improve rigidity, it is also possible for the films to contain 0.001 to 20% by weight SiO₂, preferably 1 to 15% by weight, and in particular 5 to 10% by weight, optionally doped with Al₂O₃ or ZrO₂.

Films according to the invention preferably have an industrially conventional overall thickness, for example, of 0.38, 0.76 and 1.14 mm (that is to say multiples of 0.38 mm).

The films according to the invention are generally produced by extrusion and are provided under certain conditions (melt pressure, melt temperature and die temperature) with a melt fracture surface, that is to say a stochastic surface roughness. Alternatively, an intermediate-layer film according to the invention already produced can be embossed with a generally non-stochastic roughness by an embossing process between at least one pair of rolls. Embossed films generally exhibit improved deaeration behaviour during safety glass production and are preferably used in the automotive industry.

The production and composition of films based on polyvinyl acetals is described in principle, for example, in EP 185 863 B1, EP 1 118 258 B1, WO 02/102591 A1, EP 1 118 258 B1 or EP 387 148 B1.

Irrespective of the production method, films according to the invention have a surface structure, applied on one side or more, preferably on both sides, with a roughness R^{z} of 15 to 150 μm, preferably 15 to 100 μm, more preferably 20 to 80 μm, and in particular, an R^{z} of 40 to 75 μm.

Films according to the invention are also well suited for the production of glass/film/plastic laminates, for example for permanent bonding of a glass pane to a PET layer. The bonding of two plastic panes, for example made of polycarbonate or PMMA, can also be carried out with the films according to the invention.

In particular, the films according to the invention can be used for the production of laminated safety glazings by lamination with one or more glass panes in the manner known to those skilled in the art. The laminated safety glazings can be used in the automotive industry, for example as windscreens, and in the field of architecture, for example in windows or transparent façade components, or in the manufacture of furniture.

A further use of the films according to the invention lies in the production of photovoltaic modules.

For windscreens with HUD functionality, advantageously the films of the invention are provided with a wedged-shaped cross-section. Otherwise, it is preferred to provide the films with a uniform (plan parallel) cross-section.

### Measurement Methods

The ester number EZ of polyvinyl alcohol was determined in accordance with DIN EN ISO 3681. The degree of hydrolysis HG was calculated from the ester number as follows: HG [% by weight]=100*(100−0.1535*EZ)/(100−0.0749*EZ)

The polyvinyl alcohol content and polyvinyl acetate content of PVB were determined in accordance with ASTM D 1396-92. The degree of acetalisation (=butyral content) can be calculated as the remaining portion from the sum of polyvinyl alcohol content and polyvinyl acetate content determined in accordance with ASTM D 1396-92 needed to make one hundred. Conversion from % by weight into % by mol is achieved by formulas known to a person skilled in the art.

The plasticizer content of the films was established by dissolving the film in ethanol and by subsequent quantitative gas chromatography. In order to establish the plasticizer content of the individual sub-films, the multi-layer films have to be separated again after a conditioning period of approximately one week, that is to say once plasticizer migration has largely stopped, and measured individually.

The glass transition temperature of the partly acetalised polyvinyl alcohol was determined by means of differential scanning calorimetry (DSC) in accordance with DIN 53765 with use of a heating rate of 10K/min at a temperature interval of −50° C. to 150° C. A first heating ramp, followed by a cooling ramp, followed by a second heating ramp was used. The position of the glass transition temperature was established on the measurement curve associated with the second heating ramp in accordance with DIN 51007. The DIN midpoint (Tg DIN) was defined as the point of intersection of a horizontal line at half step height with the measurement curve. The step height was defined by the vertical distance of the two points of intersection of the middle tangent with the base lines of the measurement curve before and after glass transition.

Cloud point was determined by the solubility of the polyvinyl acetal in the plasticizer to be examined. To this end, polyvinyl acetal (8 g) was suspended in the corresponding plasticizer (100 g) and heated with constant stirring until a clear solution was obtained. Once clarity had been obtained, the solution was cooled slowly on a second stirrer to room temperature. The cloud point can be determined visually by a thermometer extending into the solution.

### Measurement of the Tensile Properties of the Films

The values for the tear strengths of the film were determined by means of tensile test machine (TIRA) in accordance with ISO 527 at a rate of 200 mm/min.

The volume resistivity of the film (electrical volume resistivity) was measured in accordance with DIN IEC 60093 at a defined temperature and ambient humidity (23° C. and 85% RH and 23% RH), after which the film was conditioned for at least 24 h under these conditions. A plate electrode of type 302 132 from Fetronic GmbH and an ISO-Digi 5 kV resistivity measuring device from Amprobe were used to carry out the measurement. The test voltage was 2.5 kV, the waiting period between application of the test voltage and determination of the measured value was 60 sec. In order to ensure sufficient contact between the flat plates of the measurement electrode and the film, the surface roughness Rz of the film measured in accordance with DIN EN ISO 4287 should be no greater than 10 μm, that is to say the original surface of the PVB film may possibly have to be smoothed by thermal recoining before the resistivity measurement is taken.

The water content or moisture content of the films was determined by the Karl Fischer method. In order to simulate the moistening behaviour under humid conditions, the film was stored beforehand for 24 h at 23° C. and 85% RH and 23% RH.

The exudation of plasticizer was determined visually after a week's storage of a film at 23° C. and 50% relative humidity.

### EXAMPLES

### 1) Polyvinyl (N) Acetal Having a Polyvinyl Alcohol Content of 20.3% by Weight

100 parts by weight of the polyvinyl alcohol Mowiol 28-99 (commercial product from Kuraray Europe GmbH with a mean degree of polymerisation of 1700) were dissolved in 975 parts by weight of water while heating to 90° C. 57.5 parts by weight of n-butyraldehyde were added at a temperature of 40° C., and 75 parts by weight of 20% hydrochloric acid were added at a temperature of 12° C., while stirring. The mixture was heated to 73° C. after precipitation of the polyvinyl butyral (PVB) and was stirred at this temperature for two hours. After cooling to room temperature, the PVB was separated off, washed neutral with water, and dried. A polyvinyl(n)butyral (n-PVB) having a polyvinyl alcohol content of 20.3% by weight and a polyvinyl acetate content of 0.9% by weight was obtained.

### 2) Polyvinyl (N) Acetal Having a Polyvinyl Alcohol Content of 11.9% by Weight

100 parts by weight of the polyvinyl alcohol Mowiol 30-92 (commercial product from Kuraray Europe GmbH with a mean degree of polymerisation of 2100) were dissolved in 975 parts by weight of water while heating to 90° C. 66.6 parts by weight of n-butyraldehyde and 0.06 parts by weight of glutardialdehyde were added at a temperature of 40° C., and 100 parts by weight of 20% hydrochloric acid were added at a temperature of 12° C., while stirring. The mixture was heated to 69° C. after precipitation of the polyvinyl butyral (PVB) and was stirred at this temperature for two hours. After cooling to room temperature, the PVB was separated off, washed neutral with water, and dried. A A polyvinyl(n)butyral (n-PVB) having a polyvinyl alcohol content of 11.9% by weight and a polyvinyl acetate content of 8.8% by weight was obtained.

### 3-4) Polyvinyl (N) Acetal with a Polyvinyl Alcohol Content of 14.1% by Weight and 15.1% by Weight Respectively

The syntheses were carried out in accordance with Example 2, wherein the amount of n-butyraldehyde was varied. 56.8 and 55.8 parts by weight of n-butyraldehyde were used respectively. Polyvinyl(n)butyral (n-PVB) with polyvinyl alcohol contents of 14.1% by weight and 15.1% by weight respectively were obtained accordingly.

### 5) Polyvinyl (N) Acetal Having a Polyvinyl Alcohol Content of 14.5% by Weight

100 parts by weight of the polyvinyl alcohol Mowiol 28-99 (commercial product from Kuraray Europe GmbH) were dissolved in 975 parts by weight of water while heating to 90° C. 67.4 parts by weight of n-butyraldehyde and 0.055 parts by weight of glutardialdehyde were added at a temperature of 40° C., and 100 parts by weight of 20% hydrochloric acid were added at a temperature of 12° C., while stirring. After precipitation of the polyvinyl butyral (PVB), the mixture was heated to 69° C. and stirred at this temperature for two hours. After cooling to room temperature, the PVB was separated off, washed neutral with water, and dried. A polyvinyl(n)butyral (n-PVB) having a polyvinyl alcohol content of 14.5% by weight and polyvinyl acetate content of 1.1% by weight was obtained.

### 6) Polyvinyl (N) Acetal Having a Polyvinyl Alcohol Content of 16.0% by Weight

The syntheses were carried out in accordance with Example 5, wherein the amount of n-butyraldehyde was varied. 62 parts by weight of n-butyraldehyde were used. A polyvinyl(n)butyral (n-PVB) with a polyvinyl alcohol content of 16.0% by weight was obtained accordingly.

### 7) Polyvinyl (Iso)Acetal Having a Polyvinyl Alcohol Content of 20.3% by Weight

100 parts by weight of the polyvinyl alcohol Mowiol 28-99 (commercial product from Kuraray Europe GmbH) were dissolved in 975 parts by weight of water while heating to 90° C. 57.6 parts by weight of iso-butyraldehyde were added at a temperature of 40° C., and 75 parts by weight of 20% hydrochloric acid were added at a temperature of 12° C., while stirring. After precipitation of the polyvinyl butyral (PVB), the mixture was heated to 73° C. and stirred at this temperature for two hours. After cooling to room temperature, the PVB was separated off, washed neutral with water, and dried. A polyvinyl(iso)butyral (i-PVB) having a polyvinyl alcohol content of 20.3% by weight and polyvinyl acetate content of 1.2% by weight was obtained.

### 8) Polyvinyl (Iso)Acetal Having a Polyvinyl Alcohol Content of 14.4% by Weight

100 parts by weight of the polyvinyl alcohol Mowiol 30-92 (commercial product from Kuraray Europe GmbH) were dissolved in 975 parts by weight of water while heating to 90° C. 68.6 parts by weight of iso-butyraldehyde and 0.06 parts by weight of glutardialdehyde were added at a temperature of 40° C., and 100 parts by weight of 20% hydrochloric acid were added at a temperature of 12° C., while stirring. After precipitation of the polyvinyl butyral (PVB), the mixture was heated to 69° C. and stirred at this temperature for two hours. After cooling to room temperature, the PVB was separated off, washed neutral with water, and dried. A polyvinyl(iso)butyral (i-PVB) having a polyvinyl alcohol content of 14.4% by weight and polyvinyl acetate content of 8.7% by weight was obtained.

### 9-11) Polyvinyl (Iso)Acetal Having a Polyvinyl Alcohol Content of 15.6% by Weight, 16.4% by Weight and 17.9% by Weight Respectively

The syntheses were carried out in accordance with Example 8, wherein the amount of iso-butyraldehyde was varied. 67.6, 66.6 and 60.8 parts by weight of iso-butyraldehyde were used respectively. Polyvinyl(iso)butyral (i-PVB) with polyvinyl alcohol content of 15.6% by weight, 16.4% by weight and 17.9% by weight respectively was obtained accordingly.

### 12) Polyvinyl (Iso)Acetal Having a Polyvinyl Alcohol Content of 15.8% by Weight

100 parts by weight of the polyvinyl alcohol Mowiol 28-99 (commercial product from Kuraray Europe GmbH) were dissolved in 975 parts by weight of water while heating to 90° C. 65 parts by weight of iso-butyraldehyde and 0.055 parts by weight of glutardialdehyde were added at a temperature of 40° C., and 170 parts by weight of 20% hydrochloric acid were added at a temperature of 12° C., while stirring. After precipitation of the polyvinyl butyral (PVB), the mixture was heated to 69° C. and stirred at this temperature for one hour. After cooling to room temperature, the PVB was separated off, washed neutral with water, and dried. A polyvinyl(iso)butyral (i-PVB) having a polyvinyl alcohol content of 15.8% by weight and polyvinyl acetate content of 0.9% by weight was obtained.

### 13) Polyvinyl (Iso)Acetal Having a Polyvinyl Alcohol Content of 16.3% by Weight

The syntheses were carried out in accordance with Example 12, wherein the amount of iso-butyraldehyde was varied. 64 parts by weight of iso-butyraldehyde were used. A polyvinyl(iso)butyral (i-PVB) with a polyvinyl alcohol content of 16.3% by weight was obtained accordingly.

### 14) Polyvinyl (Iso)Acetal Having a Polyvinyl Alcohol Content of 18.2% by Weight

100 parts by weight of the polyvinyl alcohol Mowiol 28-99 (commercial product from Kuraray Europe GmbH) were dissolved in 975 parts by weight of water while heating to 90° C. 60.8 parts by weight of iso-butyraldehyde were added at a temperature of 40° C., and 75 parts by weight of 20% hydrochloric acid were added at a temperature of 12° C., while stirring. After precipitation of the polyvinyl butyral (PVB), the mixture was heated to 73° C. and stirred at this temperature for two hours. After cooling to room temperature, the PVB was separated off, washed neutral with water, and dried. A polyvinyl(iso)butyral (i-PVB) having a polyvinyl alcohol content of 18.2% by weight and polyvinyl acetate content of 0.9% by weight was obtained.

### 15-17) Polyvinyl (Iso)Acetal Having a Polyvinyl Alcohol Content of 18.2% by Weight, 19.4% by Weight, 20.5% by Weight and 22.3% by Weight Respectively

The syntheses were carried out in accordance with Example 14, wherein the amount of iso-butyraldehyde was varied. 60.8, 59.4, 57.5 and 55.4 parts by weight of iso-butyraldehyde were used respectively. Polyvinyl(iso)butyral (i-PVB) with a polyvinyl alcohol contents of 18.2% by weight, 19.4% by weight, 20.5% by weight and 22.3% by weight respectively were obtained accordingly.

### Production of Films

Films of the composition according to Table 1 were produced by extrusion.

It can be seen in Table 1 that films according to the invention have a higher softening point with constant PVA and plasticizer content compared to the comparative films based on n-butyraldehyde. The plasticizer compatibility with comparable PVA content is better in the films according to the invention, as shown in examples 6 and 7 and 2 and 3.

Table 2 shows physical data regarding the films. It shows that films according to the invention have lower moisture absorption with constant PVA content and plasticizer content. In addition, it can be seen clearly that films according to the invention have a much greater electrical volume resistivity than comparable films based on n-butyraldehyde, which is advantageous for use in solar modules.

The mechanical properties of films according to the invention can be easily adjusted by the use of poly(iso)acetals via the plasticizer and the PVA content. It can be seen in examples 1 and 7 that approximately identical tear strengths are obtained with constant PVA and plasticizer content.

The abbreviations used in the tables have the following meanings:

3G8 triethylene glycol-bis-2-ethylhexanoate
DINCH 1,2-cyclohexane dicarboxylic acid diisononyl ester
DINA diisononyl adipate
DBEA: di-(2-butoxyethyl) adipate
The following ratios by weight were used in the mixtures 3G8:DBEA=10:1; DINCH:DINA=1:1.
Cloudiness: cloud point in 3G8 [° C.]
PVA: proportion of polyvinyl alcohol groups in [% by weight]
P content plasticizer content [% by weight]
Exudation plasticizer exudation (visual)

TABLE 1

| Example | Aldehyde | PVA | Plasticizer* | P content | Tg [° C.] | Cloudiness | Exudation |
|---|---|---|---|---|---|---|---|
| 1 | n-butyraldehyde | 20.3 | 3G8/DBEA | 27.5 | 19.1 | 132.5 | no |
| 2 | n-butyraldehyde | 11.9 | | | | 54 | |
| 3 | n-butyraldehyde | 14.1 | 3G8/DBEA | 39 | −6.02 | 56 | yes |
| 4 | n-butyraldehyde | 15.1 | 3G8/DBEA | 39 | −4.60 | | yes |
| 5 | n-butyraldehyde | 14.5 | DINCH/DINA | 28 | 14.34 | | no |
| 6 | n-butyraldehyde | 16.0 | | | | 78 | |
| 7 | iso-butyraldehyde | 20.3 | 3G8/DBEA | 27.5 | 20.48 | 97.5 | no |
| 8 | iso-butyraldehyde | 14.4 | 3G8/DBEA | 39 | −7.65 | | no |
| 9 | iso-butyraldehyde | 15.6 | 3G8/DBEA | 39 | −10.09 | | no |
| 10 | iso-butyraldehyde | 16.4 | 3G8/DBEA | 39 | −8.65 | | no |
| 11 | iso-butyraldehyde | 17.9 | 3G8/DBEA | 39 | −6.44 | | no |
| 8 | iso-butyraldehyde | 14.4 | 3G8/DBEA | 37.5 | −8.73 | | no |
| 9 | iso-butyraldehyde | 15.6 | 3G8/DBEA | 37.5 | −7.98 | | no |
| 10 | iso-butyraldehyde | 16.4 | 3G8/DBEA | 37.5 | −8.54 | | no |
| 11 | iso-butyraldehyde | 17.9 | 3G8/DBEA | 37.5 | −4.40 | | no |
| 12 | iso-butyraldehyde | 15.8 | DINCH/DINA | 28 | 20.34 | 42 | no |
| 13 | iso-butyraldehyde | 16.3 | DINCH/DINA | 28 | 17.44 | 53 | no |
| 14 | iso-butyraldehyde | 18.2 | DINCH/DINA | 28 | 21.06 | 81 | no |
| 15 | iso-butyraldehyde | 19.4 | DINCH/DINA | 28 | 23.77 | 93.5 | no |
| 16 | iso-butyraldehyde | 20.5 | 308/DBEA | 28.2 | 18.76 | 104 | no |
| 17 | iso-butyraldehyde | 22.3 | 3G8/DBEA | 28.8 | 19.17 | 123 | no |

TABLE 2

| | | Electrical | Electrical | | |
|---|---|---|---|---|---|
| | | volume | volume | Water | Water |
| | Tear | resistivity | resistivity | content | content |
| | strength | 23% RH | 85% RH | at 23% | at 85% |
| Example | [N/mm²] | [ohm × cm] | [ohm × cm] | RH | RH |
| 1 | 29.8 | 1.2 × 10¹¹ | 5.6 × 10¹⁰ | 0.46 | 2.51 |
| 7 | 30.1 | 9.6 × 10¹² | 5.6 × 10¹¹ | 0.41 | 2.38 |
| 14 | 28.5 | 3.4 × 10¹² | 9.5 × 10¹⁰ | 0.42 | 2.31 |
| 15 | 29.8 | 1.1 × 10¹² | 1.6 × 10¹¹ | 0.45 | 2.5 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A film comprising a mixture of at least one non-aromatic plasticizer having a polarity, expressed by the formula 100×O/(C+H), of less than or equal to 9.4 wherein O, C and H represent the number of oxygen, carbon and hydrogen atoms in the plasticizer molecule, and a polyvinyl (iso)acetal having a proportion of polyvinyl (iso)acetal groups of 60 to 85% by weight and a proportion of polyvinyl alcohol groups of 14 to 40% by weight.

2. The film of claim 1, wherein the polyvinyl (iso)acetal has a mean degree of polymerisation between 200 and 2800.

3. The film of claim 1, wherein at least one non-aromatic plasticizer selected from the group consisting of di-2-ethylhexyl sebacate (DOS), di-2-ethylhexyl adipate (DOA), di-2-ethylhexyl phthalate (DOP), triethylene glycol-bis-2-propyl hexanoate, triethylene glycol-bis-1-nonanoate, di-2-butoxyethyl sebacate (DBES), triethylene glycol-bis-2-ethylhexanoate (3G8), and 1,2-cyclohexane dicarboxylic acid diisononyl ester (DINCH) is used as a plasticizer.

4. The film of claim 2, wherein at least one non-aromatic plasticizer selected from the group consisting of di-2-ethylhexyl sebacate (DOS), di-2-ethylhexyl adipate (DOA), di-2-ethylhexyl phthalate (DOP), triethylene glycol-bis-2-propyl hexanoate, triethylene glycol-bis-1-nonanoate, di-2-butoxyethyl sebacate (DBES), triethylene glycol-bis-2-ethylhexanoate (3G8), and 1,2-cyclohexane dicarboxylic acid diisononyl ester (DINCH) is used as a plasticizer.

5. The film of claim 1, wherein the polyvinyl (iso)acetal groups of the polyvinyl (iso)acetal are obtained by reacting at least one polyvinyl alcohol with one or more aliphatic keto compounds containing 4 to 10 carbon atoms and having at least one branch alpha or beta to the keto group.

6. The film of claim 2, wherein the polyvinyl (iso)acetal groups of the polyvinyl (iso)acetal are obtained by reacting at least one polyvinyl alcohol with one or more aliphatic keto compounds containing 4 to 10 carbon atoms and having at least one branch alpha or beta to the keto group.

7. The film of claim 3, wherein the polyvinyl (iso)acetal groups of the polyvinyl (iso)acetal are obtained by reacting at least one polyvinyl alcohol with one or more aliphatic keto compounds containing 4 to 10 carbon atoms and having at least one branch alpha or beta to the keto group.

8. The film of claim 4, wherein the polyvinyl (iso)acetal groups of the polyvinyl (iso)acetal are obtained by reacting at least one polyvinyl alcohol with one or more aliphatic keto compounds containing 4 to 10 carbon atoms and having at least one branch alpha or beta to the keto group.

9. The film of claim 1, wherein the polyvinyl (iso)acetal contains a proportion of polyvinyl acetate groups of 0.1 to 15% by weight.

10. The film of claim 2, wherein the polyvinyl (iso)acetal contains a proportion of polyvinyl acetate groups of 0.1 to 15% by weight.

11. The film of claim 3, wherein the polyvinyl (iso)acetal contains a proportion of polyvinyl acetate groups of 0.1 to 15% by weight.

12. The film of claim 4, wherein the polyvinyl (iso)acetal contains a proportion of polyvinyl acetate groups of 0.1 to 15% by weight.

13. The film of claim 5, wherein the polyvinyl (iso)acetal contains a proportion of polyvinyl acetate groups of 0.1 to 15% by weight.

14. The film of claim 6, wherein the polyvinyl (iso)acetal contains a proportion of polyvinyl acetate groups of 0.1 to 15% by weight.

15. A glazing laminate suitable for use in the automotive industry, in windscreens, in the field of architecture, in façade components, or for the production of photovoltaic modules, comprising at least one glass or plastic glazing component and a film of claim 1.
